(19) United States
(12) Patent Application Publication
(10) Pub. No.: US 2024/0068438 A1
(43) Pub. Date: Feb. 29, 2024

(54) PROTECTIVE CAP FOR A LEADING EDGE OF A WIND TURBINE BLADE

(71) Applicants: BLADE DYNAMICS LIMITED, Hampshire (GB); LM WIND POWER A/S, Kolding (DK)

(72) Inventors: Manish MUKHERJEE, Hampshire (GB); Lars Bo HANSEN, Kolding (DK); Michael Drachmann HAAG, Kolding (DK)

(21) Appl. No.: 18/269,913

(22) PCT Filed: Dec. 21, 2021
(86) PCT No.: PCT/EP2021/087029

§ 371 Date: Jun. 27, 2023

(30) Foreign Application Priority Data
Dec. 28, 2020 (GB) 2020661.1

(51) Int. Cl. F03D 1/06; F03D 80/30

(52) U.S. Cl. CPC F03D 1/0688; F03D 80/301; F05B 2230/232; F05B 2230/60

(57) ABSTRACT

The present invention relates to a protective cap for protecting a leading edge of a wind turbine blade. The protective cap comprises first and second attachment portions for attaching the protective cap to a suction side and a pressure side of the wind turbine blade and comprises a first metal layer and a second metal layer, the first and second metal layers extending between the first and the second attachment portions, and the first metal layer and the second metal layer are at least partly spaced apart. A wind turbine blade with a protective cap is also provided. Methods for manufacturing a protective cap and a wind turbine blade with a protective cap are also provided.

### TECHNICAL FIELD

The present invention relates to a protective cap for a leading edge of a wind turbine blade.

### BACKGROUND

As wind turbine blades increase in length, the speed of the tip of the wind turbine blades increases as well. For wind turbines located offshore, noise may be less of a concern and higher tip speeds are allowed. High tip speeds result in increased wear by impact with particles, including dust, rain, snow, hail etc. Such wear directly affects the productivity of the wind turbine.

It is known to attach a protective element to the leading edge of a wind turbine blade in order to prevent or at least reduce erosion of the wind turbine blade. However, many existing solutions have not taken lightning strikes into account, which may adversely affect a protective element on the leading edge of a wind turbine blade, especially when the protective element is made primarily of a metallic material.

Thus, there is a need for an alternative protection solution for protecting leading edges of wind turbine blades.

### SUMMARY OF THE INVENTION

In a first aspect, the invention provides a protective cap for protecting a leading edge of a wind turbine blade, the wind turbine blade extending along a longitudinal axis between a root end of the wind turbine blade and a tip end of the wind turbine blade, the protective cap comprising a first attachment portion for attaching the protective cap to a suction side of the wind turbine blade and comprising a second attachment portion for attaching the protective cap to a pressure side of the wind turbine blade, the protective cap further comprising:
a first metal layer having a first side and a second side opposite the first side, the first metal layer extending between the first attachment portion and the second attachment portion of the protective cap,
a second metal layer having a first side and a second side opposite the first side, the second metal layer extending between the first attachment portion and the second attachment portion of the protective cap, the first metal layer and the second metal layer being at least partly spaced apart.

In case lightning strikes the first metal layer of the protective cap, current is not conducted to the second metal layer because they are at least partly spaced apart. Current can flow to the second metal layer via the attachment portions where the first metal layer and the second metal layer are directly connected. As a result of the spacing, heating of the first metal layer by a lightning strike will damage the second metal layer very little, if at all. Thus, even if the first metal layer is damaged due to heating or a crater is created in the first metal layer, even to the extent that a hole is created through the first metal layer, the wind turbine blade will remain protected by the second metal layer of the protective cap.

In some embodiments, the second metal layer is, when the protective cap is attached to the wind turbine blade via the first and second attachment portions, located between the first metal layer and the leading edge of the wind turbine blade. In other words, when the wind turbine blade rotates, it is the first metal layer that attacks the environment, whereas the second metal layer is protected by the first metal layer.

The first side of the second metal layer can be considered as being oriented towards the second side of the first metal layer. In some embodiments, a first part of the first side of the second metal layer is spaced apart from the second side of the first metal layer, wherein a total area of the first part is at least 0.7 times a total area of the first side of the second metal layer. That is, at least 70% of the first side of the second metal layer is not in electrical contact with the first metal layer. A part or parts of the first metal layer and the second metal layer may be in contact in order to reduce vibrations between the two metal layers. However, the free area must be large enough that the conductivity between the layers is not too high. A free area of 85% of the total area of the first side of the second metal layer has been found to be an acceptable amount. If the value is less, the conductivity tends to be too high to achieve the protection of the second metal layer described above.

Since the effect relies on a degree of spacing between the first metal layer and the second metal layer, a substantially uniform (or uniform) spacing between the first metal layer and the second metal layer may be advantageous.

In some embodiments, the first metal layer and the second metal layer are spaced part everywhere between the first attachment portion and the second attachment portion.

The first metal layer and the second metal layer are advantageously spaced apart no more than about 5 mm, such as 5 mm.

In some embodiments, the protective cap comprises a foam layer having a first side attached to the second side of the second metal layer. The foam Is an interlayer material that can secure good adhesion and prevent air cavities where moist can build up over time. A combination of hardness thickness also reduces the mechanical loads on the composite laminate minimising possible structural damages. In some embodiments, a fabric is attached to a second side of the foam layer opposite the first side of the foam layer. The fabric is advantageously non-conductive. The fabric, for instance Kevlar, can help further protect the wind turbine blade part covered by the protective cap.

In some embodiments, a thickness of the first metal layer and/or the second metal layer is at most 5 mm, such as at most 2 mm, such as at most 0.5 mm. The optimal thickness may depend for instance of the speed of the blade and the overall size of the blades. A blade with a relatively long chord may benefit from relatively thick metal layers. However, it is also a balance between weight and degree of protection. A thickness in the range 0.5 mm to 1 mm strikes in a good balance.

In some embodiments, both the first metal layer and the second metal layer have a thickness of at most 1 mm, such as at most 0.5 mm.

Often, the thickness of the first metal layer is identical to the thickness of the second metal layer, as the same sheet material is used to make both metal layers. For instance, the protective cap may comprise:
a first metal sheet having a first edge portion and a second edge portion opposite the first edge portion, the first metal layer being part of the first metal sheet between the first edge portion of the first metal sheet and the second edge portion of the first metal sheet,
a second metal sheet having a first edge portion and a second edge portion opposite the first edge portion, wherein the first edge portion of the second metal sheet is in welded connection with the first edge portion of the first metal sheet, and the second edge portion of the second metal sheet is in welded connection with the second edge portion of the first metal sheet, the second metal layer being part of the second metal sheet between the first edge portion of the second metal sheet and the second edge portion of the second metal sheet,
where the first attachment portion of the protective cap comprises the first edge portion of the first metal sheet and the first edge portion of the second metal sheet, and the second attachment portion comprises the second edge portion of the first metal sheet and the second edge portion of the second metal sheet.

The first metal sheet is typically bent in a smooth curve to resemble that front of a “nor-mal” wind turbine blade in order to provide an aerodynamically advantageous shape. The second metal sheet is bent in a very similar manner in order to obtain the desired spacing between the first metal layer and the second metal layer.

The metal layers may be formed by casting in a mould, by metal sintering, by drawing, or by pressing sheets.

In some embodiments, at least a part of the protective cap is produced by additive manufacturing. In some cases, for instance if the chord varies quickly along the leading edge, it may be difficult to produce the protective cap by bending metal sheets. In such a case, additive manufacturing can be advantageous.

In some embodiments, the protective cap comprises an adhesive or a foam between the first metal layer and the second metal layer. This may reduce for instance vibrations in the metal layers and ensure that the especially the first metal layer, which is the layer that is exposed, is mechanically well connected.

A second aspect of the invention provides a wind turbine blade assembly, comprising:
a wind turbine blade extending along a longitudinal axis between a root end of the wind turbine blade and a tip end of the wind turbine blade, the wind turbine blade having a leading edge and a trailing edge and a suction side extending between the leading edge and the trailing edge and a pressure side extending between the leading edge and the trailing edge, and
a protective cap in accordance with any of claims 1-15, wherein the first attachment portion of the protective cap is attached to the suction side of the wind turbine blade and the second attachment portion of the protective cap is attached to the pressure side of the wind turbine blade, the protective cap extending along at least a first part (L₁) of the leading edge of the wind turbine blade, whereby the first part of the leading edge is protected by the protective cap.

In some embodiments, the leading edge at the first part (L₁) of the wind turbine blade is spaced from the protective cap. This provides electrical isolation between the leading edge of the wind turbine blade the metallic protective cap and gives a better lightning capturing efficiency.

In some embodiments, any wind turbine blade airfoil within at least a part of the first part (L₁) of the leading edge of the wind turbine blade is characterised in that the protective cap extends backwards on the pressure side and the suction side at most to a chord coordinate (xₘ) of maximum thickness (tₘ) of said airfoil. (The coordinate system defined by the chord that characterises any given airfoil is well known and will not be described in further detail.) This provides strong protection of the leading edge while not adding too much weight. In some embodiments, the protective cap extends backwards on the pressure side and the suction side at most to a chord coordinate x=0.4c, where c is the length of the chord of said airfoil. That is, the protective cap does not extend beyond those points of the pressure side and the suction side that have a chord coordinate x=0.4c. In some embodiments, the protective cap extends backwards on the pressure side and the suction side at most to a chord coordinate x=0.3c.

In some embodiments, the wind turbine blade assembly comprises a first conductor electrically that connects the protective cap to a downconductor connector of the wind turbine blade.

In other embodiments, the protective cap is electrically isolated from a downconductor of the wind turbine blade. In some scenarios, a segmented lightning diverter is advantageously arranged near, but not in contact, with the protective cap, to nevertheless allow current to be conducted from the protective cap to ground (via the segmented lightning diverter and an electrical connection between the segmented lightning diverter and a downconductor in the blade).

In some embodiments, the first metal layer and/or the second metal layer comprise or are made of one or more of: stainless steel, Titanium, a Nickel alloy, Aluminium, or one or more alloys comprising Iron, Titanium, a Nickel alloy, Chromium, and/or Aluminium.

In some embodiments, a mass fraction of Copper in each of the first and second metal layer is at most 5%, such as at most 1%. In some embodiments, the metal layers do not contain Copper.

A third aspect of the invention provides a method for manufacturing a protective cap for protecting a leading edge of a wind turbine blade, the wind turbine blade extending along a longitudinal axis between a root end of the blade and a tip end of the blade, the protective cap comprising a first attachment portion for attaching the protective cap to a suction side of the wind turbine blade and comprising a second attachment portion for attaching the protective cap to a pressure side of the wind turbine blade, the protective cap further comprising a first metal layer and a second metal layer extending between the first attachment portion and the second attachment portion. The method comprises:
providing a first metal sheet having a first edge portion and a second edge portion opposite the first edge portion, a part of the first metal sheet between the first edge portion of the first metal sheet and the second edge portion of the first metal sheet forming the first metal layer,
providing a second metal sheet having a first edge portion and a second edge portion opposite the first edge portion, a part of the second metal sheet between the first edge portion of the second metal sheet and the second edge portion of the second metal sheet forming the second metal layer,
welding the first edge portion of the second metal sheet to the first edge portion of the first metal sheet, the welded-together first edge portions forming the first attachment portion of the protective cap,
welding the second edge portion of the second metal sheet to the second edge portion of the first metal sheet, the welded-together second edge portions forming the second attachment portion of the protective cap,
the first metal sheet and the second metal sheet being shaped and welded together such that the first metal layer and the second metal layer are at least partly spaced apart.

A fourth aspect of the invention provides a method for manufacturing a wind turbine blade assembly comprising a wind turbine blade and a protective cap protecting a leading edge of the wind turbine blade, the method comprising:
providing a wind turbine blade extending along a longitudinal axis between a root end of the wind turbine blade and a tip end of the wind turbine blade, the wind turbine blade having a leading edge and a trailing edge and a suction side extending between the leading edge and the trailing edge and a pressure side extending between the leading edge and the trailing edge,
providing a protective cap in accordance with an embodiment of the first aspect of the invention,
attaching the first attachment portion of the protective cap to the suction side of the wind turbine blade and attaching the second attachment portion of the protective cap to the pressure side of the wind turbine blade such that the protective cap extends along at least a first part (L₁) of the leading edge of the wind turbine blade, whereby the first part (L₁) of the leading edge is protected by the protective cap.

In some embodiments, for any wind turbine blade airfoil within the first part (L₁) of the leading edge of the wind turbine blade, the protective cap extends backwards on the pressure side and the suction side at most to a chord coordinate (xₘ) of maximum thickness (tₘ) of said airfoil.

In some embodiments, the method further comprises electrically connecting the protective cap to a downconductor connector of the wind turbine blade using a first conductor.

### BRIEF DESCRIPTION OF THE DRAWINGS

The invention is explained in detail below by way of example with reference to the drawings.

FIG. 1 schematically shows a wind turbine having three wind turbine blades.

FIG. 2 schematically shows an exemplary wind turbine blade.

FIG. 3 schematically shows an exemplary wind turbine blade with a protective cap.

FIG. 4 schematically shows an exemplary airfoil of a wind turbine blade with a protective cap.

FIG. 5 schematically shows a cross-section of a wind turbine blade with a protective cap.

FIG. 6 schematically shows an airfoil of a wind turbine blade suitable for attachment of a protective cap.

FIG. 7 schematically shows a protective cap.

FIGS. 8-9 schematically show various embodiments of a protective cap.

FIG. 10 schematically shows two sheets for manufacturing a protective cap.

### DETAILED DESCRIPTION OF SELECTED EMBODIMENTS

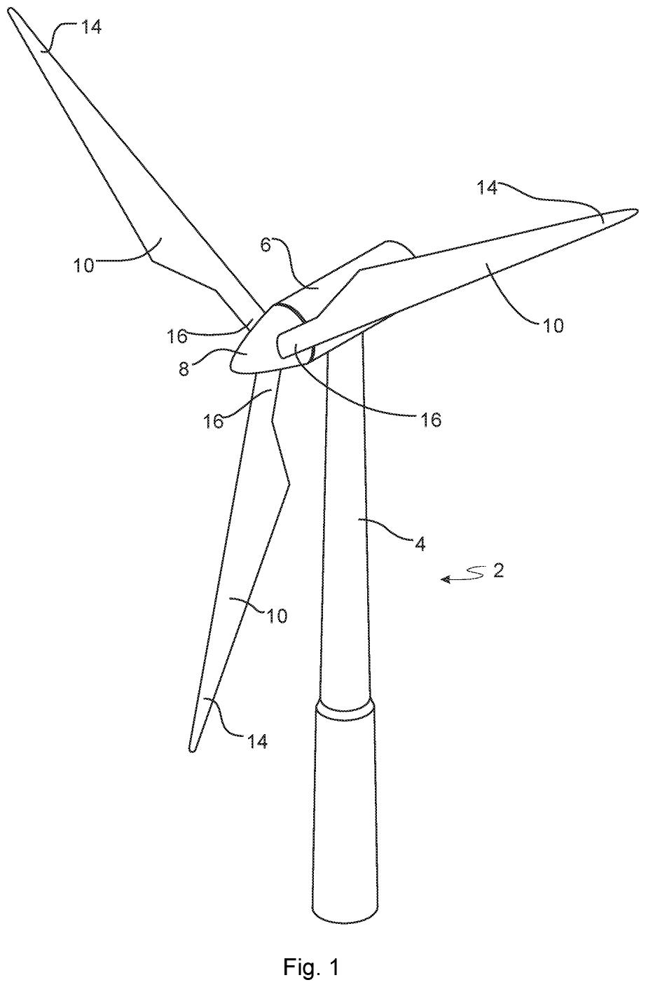

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a root end 16 nearest the hub and a blade tip 14 furthest from the hub 8.

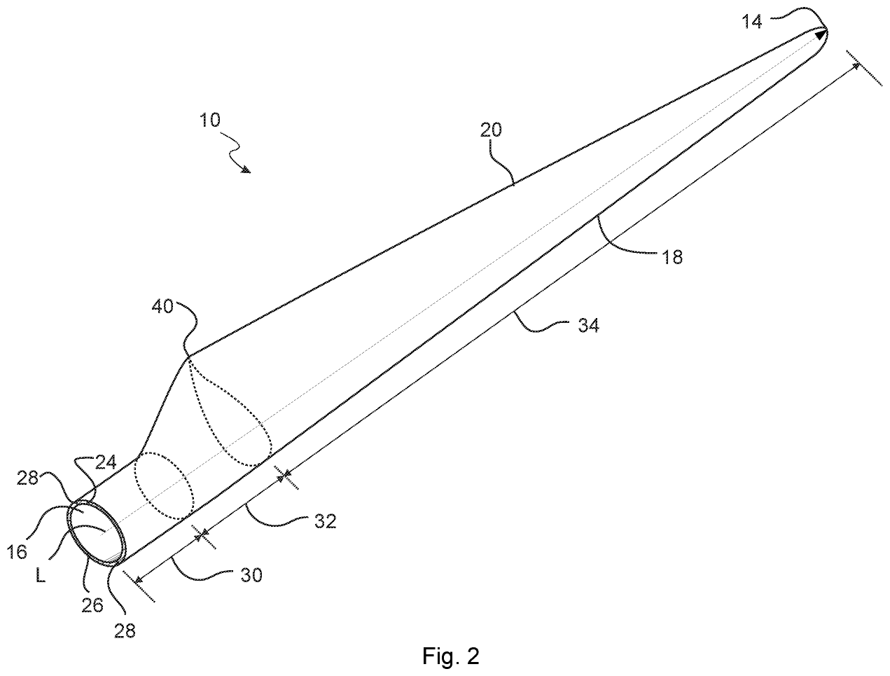

FIG. 2 shows a schematic view of an exemplary wind turbine blade 10. The wind turbine blade 10 has the shape of a conventional wind turbine blade with a root end and a tip end and comprises a root region 30 closest to the hub, a profiled or airfoil region 34 furthest away from the hub 8, and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18. The airfoil region 34, also called the profiled region, has an ideal or almost ideal blade shape with respect to generating lift, whereas the root region 30 due to structural considerations has a substantially circular or elliptical cross-section, which for instance makes it easier and safer to mount the blade 10 to the hub 8. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord in the airfoil region 34 typically decreases with increasing distance r from the hub. A shoulder 40 of the blade 10 is defined as the position, where the blade has its largest chord length. The shoulder 40 is typically provided at the boundary between the transition region 32 and the airfoil region 34.

The wind turbine blade 10 comprises a blade shell comprising two blade shell parts, a first blade shell part 24 and a second blade shell part 26, typically made of fibre-rein-forced polymer. The first blade shell part 24 is typically a pressure side or upwind blade shell part. The second blade shell part 26 is typically a suction side or downwind blade shell part. The first blade shell part 24 and the second blade shell part 26 are attached to one another with adhesive, such as glue, along bond lines or glue joints 28 extending along the trailing edge 20 and the leading edge 18 of the blade 10. Typically, the root ends of the blade shell parts 24, 26 have a semi-circular or semi-oval outer cross-sectional shape.

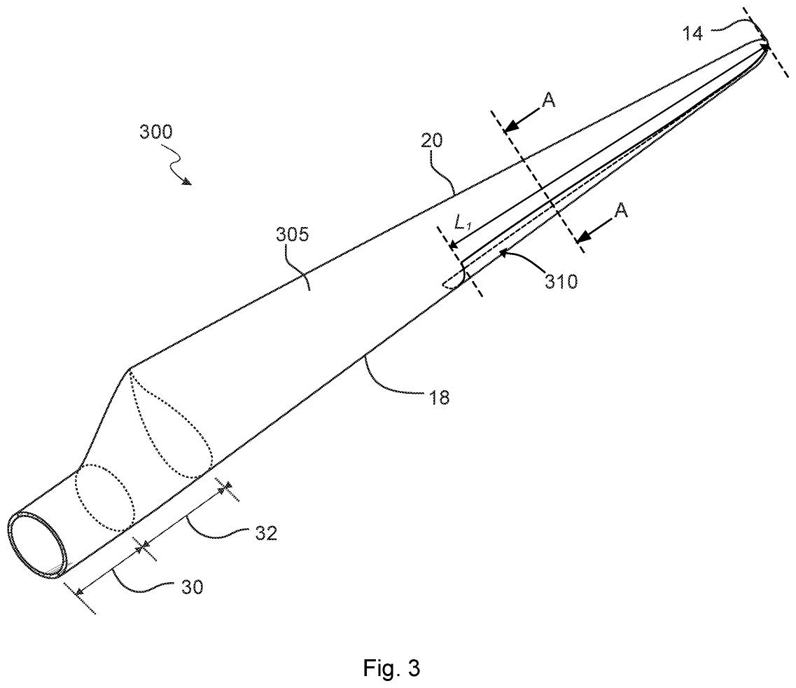

FIG. 3 schematically illustrates a wind turbine blade assembly 300 in accordance with an embodiment of the invention. The wind turbine blade assembly comprises a wind turbine blade 305 that in many ways is similar to the wind turbine blade 10 shown in FIGS. 2 and 3. The wind turbine blade assembly further comprises a protective cap 310 in accordance with an embodiment of the invention, the protective cap extending along a first part L₁ of a leading edge 18 of the wind turbine blade 305. The protective cap is located in the tip end of the blade 305 where the blade speed is the highest. In the present example, the protective cap 310 extends all the way to the tip 14, where the speed is the highest and the blade the smallest.

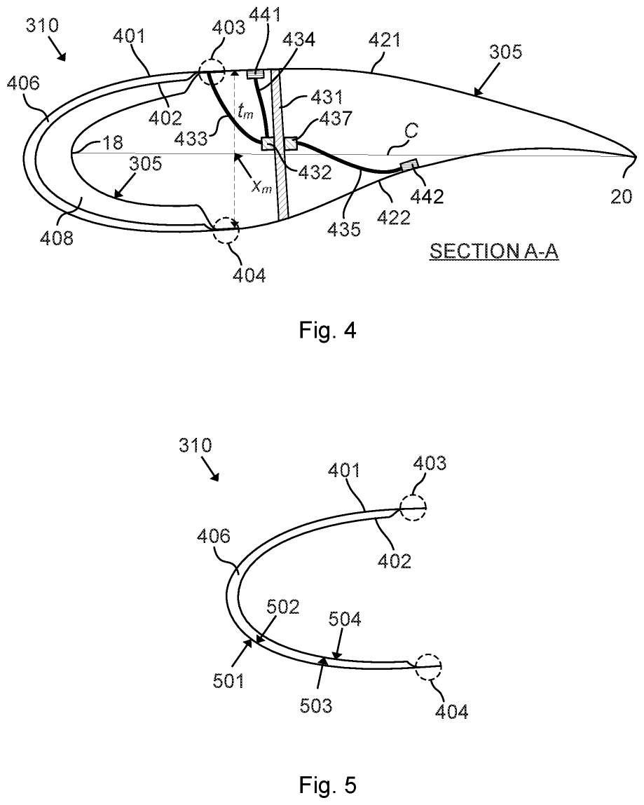

FIG. 4 illustrates the cross-section A-A indicated in FIG. 3. The airfoil of the wind turbine blade 305 has a suction side 421 and a pressure side 422 corresponding to the suction side and pressure side, respectively, of the blade 305 at the cross-section A-A. A first attachment portion 403 of the protective cap 310 connects the protective cap 310 to the suction side 421 of the wind turbine blade 305, and a second attachment portion 404 of the protective cap 310 connects the protective cap 310 to the pressure side 422 of the wind turbine blade 305. The protective cap 310 comprises a first metal layer 401 and a second metal layer 402 that both extend between the first attachment portion 403 and the second attachment portion 404. The first metal layer 401 is exposed to the environment, such as to snow and dust, whereas the second metal layer is not exposed, being located behind the first metal layer, between the first metal layer and the leading edge 18 of the wind turbine blade 305.

It is noted that the airfoil in FIG. 4 is exemplary. Wind turbine blades typically narrow towards the tip end, and the airfoil varies accordingly in shape and/or size along the longitudinal axis of the blade. Since the protective cap to some extent follows the shape of the airfoil, for instance to maximize lift and minimize noise, the “airfoil” of the protective cap will also vary accordingly.

In the embodiment in FIG. 4, the first metal layer 401 is separated from the second metal layer everywhere between the first attachment portion 403 and the second attachment portion 404, creating a space 406. In case lightning strikes the first metal layer 401 of the protective cap 310, current therefore cannot be directly conducted to the second metal layer 402 except at the attachment portions 403, 404 where the first metal layer and the second metal layer are directly connected. As a result of the spacing 406, heating of the first metal layer 401 by a lightning strike will damage the second metal layer very little, if at all. Thus, even if the first metal layer 401 is damaged due to heating or a crater is created in the first metal layer, even to the extent that a hole is created through the first metal layer 401, the wind turbine blade 305 will remain protected by the second metal layer 402 of the protective cap.

In the embodiment in FIG. 4, the protective cap 310 is furthermore spaced from the leading edge 18 of the wind turbine blade 305. A space 408 therefore exists between the wind turbine blade 305, the leading edge 18 and the protective cap 310. This further protects the wind turbine blade 305 from damaging effects from lightning strikes.

It is important that the protective cap 310 is not too heavy. Therefore, the protective cap 310 preferably does not extend backwards towards the trailing edge of the suction side 421 and the pressure side 422 beyond a chord coordinate xₘ along the chord C of the airfoil of the wind turbine blade 305, at which coordinate the airfoil has its maximum thickness tₘ of the airfoil of the wind turbine blade 305. This is illustrated in FIG. 4. The chord is a well-known concept, as is the coordinate system defined by the chord of a given airfoil. Therefore, this will not be explained in further detail.

In the embodiment in FIG. 4, the protective cap 310 is connected to a downconductor connector 432 via a first conductor 433. (The downconductor connector is in turn connected to a downconductor, not shown, for conducting lightning current to ground.) For illustration purposes, the downconductor connector is shown attached to a shear web 431 in the blade.

In another embodiment, the blade comprises a metallic lightning capture device 441 for capturing lightning. The lightning capturing device if often a component having a circular shape at the surface of the blade, in this case located so that it is exposed at the surface of the suction side 421. The lightning capturing device 441 is connected to the downconductor connector 432 via a second conductor 434. In some embodiments, the metal cap 310 is electrically isolated from the downconductor. Lightning striking the metal cap 310 may therefore be conducted to ground by sparking from the metal cap to a lightning capturing device, such as lightning capturing device 441. A minimum distance between the metal cap 310 (including the first attachment portion 403) and the lightning capturing device 441 is in the range 0.5 mm to 3 mm, such as in the range 1 mm to 2 mm.

In some embodiments, the lightning capturing device is a segmented lightning diverter. Segmented lightning diverters may be particularly convenient when a lightning capturing device (such as a lightning receptor) is located relative far from the metal cap 310, as illustrated by lightning capturing device 442, which is located closer to the trailing edge than to the leading edge 18. Lightning striking the metal cap 310 can be conducted to the downconductor via a segmented lightning diverter configured to divert lightning to the lightning capturing device 442, which in turn is connected to the downconductor via a third conductor 435 attached to a downconductor connector. Two downconductor connectors 432, 437 are shown for illustrative purposes; downconductor connectors, including the number of downconductors, are placed where convenient.

FIG. 5 shows the cross-section of the protective cap 310 in isolation, corresponding to the cross-section shown in FIG. 4. The protective cap is manufactured specifically to suit the wind turbine blade that it will ultimately be protecting.

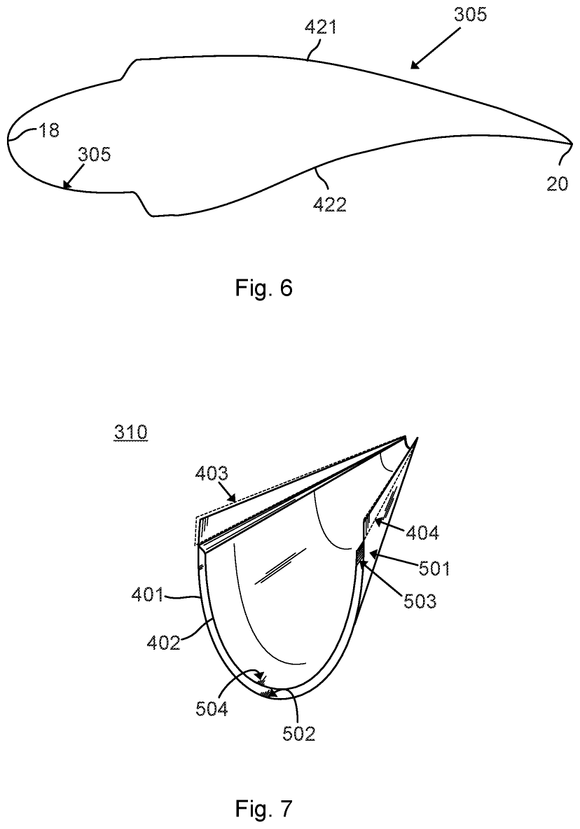

FIG. 6 shows the airfoil of the wind turbine blade 305 corresponding to the cross-section shown in FIG. 4. It is seen that the wind turbine blade is adapted such that when the protective cap 310 is attached, resulting in the assembly 300 shown in FIG. 3, noise is minimized and lift is maximized.

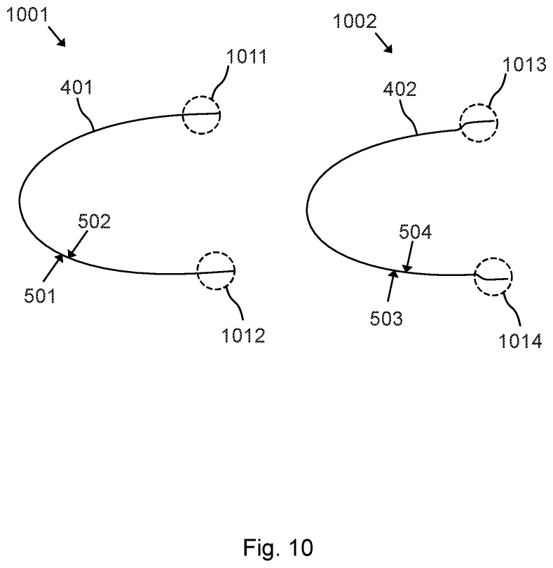

FIG. 7 shows a perspective view of the protective cap 310 in isolation. It comprises the first metal layer 401, the second metal layer 402, the first side 501 and the second side 502 of the first layer 401, the first side 503 and the second side 504 of the second layer 402, and the first and second attachment portions 403, 404. The cap 310 may for instance be made from thin metal sheets having the desired shapes. These sheets are then welded together in regions that form the first and second attachment portions 403, 404, between which the first metal layer 401 and the second metal layer 402 extend. Such sheets are further illustrated in FIG. 10.

After the protective cap 310 has been formed, it can be adhered to the wind turbine blade 305 to form the assembly 300 shown in FIG. 3.

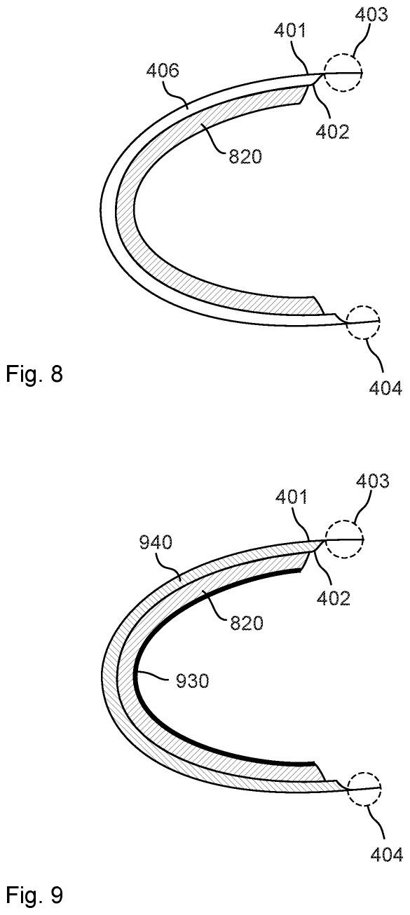

FIG. 8 shows a protective cap that further comprises a foam 820 arranged on an inner surface of the second metal layer 402. The foam Is an interlayer material that can secure good adhesion and prevent air cavities where moist can build up over time. A combination of hardness thickness also reduces the mechanical loads on the composite laminate minimising possible structural damages.

FIG. 9 shows a protective cap that further comprises an optional fabric 930 arranged on an inner surface of a foam layer 820. In the example in FIG. 9, an optional adhesive is provided between the first metal layer 401 and the second metal layer 402, which may protect the second metal layer.

FIG. 10 illustrates thin metal sheets 1001 and 1002 that form the first metal layer 401 and the second metal 402, respectively. The first metal sheet 1001 has a first edge portion 1011 and a second edge portion 1012 opposite the first edge portion 1011. A part of the first metal sheet 1001 between the first edge portion 1011 of the first metal sheet 1001 and the second edge portion 1012 of the first metal sheet 1001 constitutes the first metal layer 401. Similarly, a second metal sheet 1002 has a first edge portion 1013 and a second edge portion 1014 opposite the first edge portion 1013, and a part of the second metal sheet 1002 between the first edge portion 1013 of the second metal sheet 1002 and the second edge portion 1014 of the second metal sheet 1002 constitutes the second metal layer 402.

To manufacture the protective cap 310, shown in perspective view in FIG. 7, the first edge portions 1011, 1013 of the first and second metal sheets are welded together. Similarly, the second edge portions 1012, 1014 of the first and second metal sheets are welded together. The shape of the first metal sheet 1001 and the shape of the second metal sheet 1002 result in the space 406 (shown in FIG. 8).

Welding the two sheets 1001, 1002 together also creates the first attachment portion 403 of the protective cap 310 and the second attachment portion 404 of the protective cap, shown for instance in FIGS. 4, 5, and 7-9. The attachment portions 403, 404 are used for attaching the protective cap 310 to the suction side 421 and pressure side 422, respectively, as illustrated for instance in FIG. 4, resulting in the wind turbine blade assembly 300 shown in FIG. 3.

### LIST OF REFERENCE NUMERALS

A-A cross-section of blade in airfoil region
L longitudinal axis of wind turbine blade
tₘ maximum thickness of airfoil.
xₘ chord coordinate of maximum thickness (tₘ) of airfoil
2 wind turbine
4 tower
6 nacelle
8 hub
10 wind turbine blade
11 first blade shell part (pressure side) in airfoil region
12 second blade shell part (suction side) in airfoil region
14 blade tip, tip end
16 root end
18 leading edge
20 trailing edge
24 first blade shell part (pressure side) at root end
26 second blade shell part (suction side) at root end
28 bond lines/glue joints
30 root region
32 transition region
34 airfoil region
40 shoulder
300 wind turbine blade assembly
305 wind turbine blade
310 protective cap
401 first metal layer
402 second metal layer
403 first attachment portion
404 second attachment portion
406 spacing
408 spacing
421 suction side
422 pressure side
431 shear web
432 downconductor connector
433 first conductor
434 second conductor
435 third conductor
437 downconductor connector
441 lightning capturing device
442 lightning capturing device
501 first side of first metal layer
502 second side of first metal layer
503 first side of second metal layer
504 second side of second metal layer
820 foam
930 fabric
940 adhesive, foam
1001 first metal sheet
1002 second metal sheet
1011 first edge portion of the first metal sheet
1012 second edge portion of the first metal sheet
1013 first edge portion of the second metal sheet
1014 second edge portion of the second metal sheet

1. A protective cap (310) for protecting a leading edge (18) of a wind turbine blade (305), the wind turbine blade extending along a longitudinal axis between a root end (16) of the wind turbine blade (305) and a tip end (14) of the wind turbine blade (305), the protective cap (310) comprising a first attachment portion (403) for attaching the protective cap to a suction side (421) of the wind turbine blade (305) and comprising a second attachment portion (404) for attaching the protective cap to a pressure side (422) of the wind turbine blade, the protective cap further comprising:
a first metal layer (401) having a first side (501) and a second side (502) opposite the first side (501), the first metal layer (401) extending between the first attachment portion (403) and the second attachment portion (404) of the protective cap,
a second metal layer (402) having a first side (503) and a second side (504) opposite the first side (503), the second metal layer (402) extending between the first attachment portion (403) and the second attachment portion (404) of the protective cap, the first metal layer (401) and the second metal layer (402) being at least partly spaced apart (406).

2. A protective cap in accordance with claim 1, wherein, when the protective cap is attached to the wind turbine blade via the first and second attachment portions, the second metal layer (402) is located between the first metal layer (401) and the leading edge (18) of the wind turbine blade.

3. A protective cap in accordance with claim 1, wherein the first side (503) of the second metal layer (402) is oriented towards the second side (502) of the first metal layer (401), and wherein a first part of the first side (503) of the second metal layer (402) is spaced apart (406) from the second side (502) of the first metal layer (401), wherein a total area of the first part is at least 0.7 times a total area of the first side (503) of the second metal layer (402).

4. A protective cap in accordance with claim 3, wherein a spacing between the first metal layer (401) and the second metal layer (402) is uniform across the total area of the first side (503) of the second metal layer (402).

5. A protective cap in accordance claim 1, wherein the first metal layer (401) and the second metal layer (402) are spaced part (406) everywhere between the first attachment portion (403) and the second attachment portion (404).

6. A protective cap in accordance claim 1, further comprising a foam layer (820) having a first side attached to the second side (504) of the second metal layer (402).

7. A protective cap in accordance with claim 6, further comprising a fabric (930) attached to a second side of the foam layer (820) opposite the first side of the foam layer.

8. A protective cap in accordance with claim 1, wherein a thickness of the first metal layer and/or the second metal layer is at most 5 mm.

9. A protective cap in accordance with claim 1, wherein a thickness of the first metal layer and/or the second metal layer is at most 2 mm.

10. A protective cap in accordance with claim 1, wherein a thickness of the first metal layer and/or the second metal layer is at most 0.5 mm.

11. A protective cap in accordance with claim 1, wherein a thickness of the first metal layer and a thickness of the second metal layer are at most 1 mm.

12. A protective cap in accordance with claim 1, wherein a thickness of the first metal layer and a thickness of the second metal layer are at most 0.5 mm.

13. A protective cap in accordance with claim 1, wherein a maximum distance between the first metal layer and the second metal layer is at most 5 mm.

14. A protective cap in accordance with claim 1, wherein the protective cap (310) comprises:
a first metal sheet (1001) having a first edge portion (1011) and a second edge portion (1012) opposite the first edge portion (1011), the first metal layer (401) being part of the first metal sheet (1001) between the first edge portion (1011) of the first metal sheet (1001) and the second edge portion (1012) of the first metal sheet (1001),
a second metal sheet (1002) having a first edge portion (1013) and a second edge portion (1014) opposite the first edge portion (1013), wherein the first edge portion (1013) of the second metal sheet (1002) is in welded connection with the first edge portion (1011) of the first metal sheet (1001), and the second edge portion (1014) of the second metal sheet (1002) is in welded connection with the second edge portion (1012) of the first metal sheet (1001), the second metal layer (402) being part of the second metal sheet (1002) between the first edge portion (1013) of the second metal sheet (1002) and the second edge portion (1014) of the second metal sheet (1002),
the first attachment portion (403) of the protective cap (310) comprising the first edge portion (1011) of the first metal sheet (1001) and the first edge portion (1013) of the second metal sheet (1002), the second attachment portion (404) comprising the second edge portion (1012) of the first metal sheet (1001) and the second edge portion (1014) of the second metal sheet (1002).

15. A protective cap in accordance with claim 1, further comprising an adhesive or foam (940) between the first metal layer (401) and the second metal layer (402).

16. A wind turbine blade assembly (300) comprising:
a wind turbine blade (305) extending along a longitudinal axis between a root end (16) of the wind turbine blade and a tip end (14) of the wind turbine blade, the wind turbine blade having a leading edge (18) and a trailing edge (20) and a suction side (421) extending between the leading edge (18) and the trailing edge (20) and a pressure side (422) extending between the leading edge (18) and the trailing edge (20), and
a protective cap (310) in accordance with any of claims 1-15, wherein the first attachment portion (403) of the protective cap (310) is attached to the suction side (421) of the wind turbine blade (305) and the second attachment portion (404) of the protective cap (310) is attached to the pressure side (422) of the wind turbine blade, the protective cap extending along at least a first part (L₁) of the leading edge (18) of the wind turbine blade (305), whereby the first part (L₁) of the leading edge (18) is protected by the protective cap (310).

17. A wind turbine blade assembly in accordance with claim 16, wherein the leading edge (18) at the first part (L₁) of the wind turbine blade (305) is spaced (408) from the protective cap (310).

18. A wind turbine blade assembly in accordance with claim 16, wherein for any wind turbine blade airfoil (305) within the first part (L₁) of the leading edge (18) of the wind turbine blade, the protective cap (310) extends backwards on the pressure side and the suction side at most to a chord coordinate (xₘ) of maximum thickness (tₘ) of said airfoil (305).

19. A wind turbine blade assembly in accordance with claim 16, further comprising a first conductor (433) electrically connecting the protective cap (310) to a downconductor connector (432) of the wind turbine blade (305).

20. A wind turbine blade assembly in accordance with claim 16, wherein the protective cap is electrically isolated from a downconductor of the wind turbine blade.

21. A protective cap in accordance with any of claims 1-15 or wind turbine blade assembly in accordance with any of claims 16-20, wherein the first metal layer (401) and the second metal layer (402) comprise or are made of one or more of: stainless steel, Titanium, a Nickel alloy, Aluminium, or one or more alloys comprising Iron, Titanium, a Nickel alloy, Chromium, and/or Aluminium.

22. A method for manufacturing a protective cap (310) for protecting a leading edge (18) of a wind turbine blade (305), the wind turbine blade (305) extending along a longitudinal axis between a root end (16) of the blade and a tip end (14) of the blade, the protective cap comprising a first attachment portion (403) for attaching the protective cap to a suction side (421) of the wind turbine blade (305) and comprising a second attachment portion (404) for attaching the protective cap to a pressure side (422) of the wind turbine blade, the protective cap further comprising a first metal layer (401) and a second metal layer (402) extending between the first attachment portion (403) and the second attachment portion (404), the method comprising:
providing a first metal sheet (1001) having a first edge portion (1011) and a second edge portion (1012) opposite the first edge portion (1011), a part of the first metal sheet (1001) between the first edge portion (1011) of the first metal sheet (1001) and the second edge portion (1012) of the first metal sheet (1001) forming the first metal layer (401),
providing a second metal sheet (1002) having a first edge portion (1013) and a second edge portion (1014) opposite the first edge portion (1013), a part of the second metal sheet (1002) between the first edge portion (1013) of the second metal sheet (1002) and the second edge portion (1014) of the second metal sheet (1002) forming the second metal layer (402),
welding the first edge portion (1013) of the second metal sheet (1002) to the first edge portion (1011) of the first metal sheet (1001), the welded-together first edge portions (1011, 1013) forming the first attachment portion (403) of the protective cap (310),
welding the second edge portion (1014) of the second metal sheet (1002) to the second edge portion (1012) of the first metal sheet (1001), the welded-together second edge portions (1012, 1014) forming the second attachment portion (404) of the protective cap (310),
the first metal sheet (1001) and the second metal sheet (1002) being shaped and welded together such that the first metal layer (401) and the second metal layer (402) are at least partly spaced apart (406).

23. A method for manufacturing a wind turbine blade assembly (300) comprising a wind turbine blade and a protective cap protecting a leading edge of the wind turbine blade, the method comprising:
providing a wind turbine blade (305) extending along a longitudinal axis between a root end (16) of the wind turbine blade and a tip end (14) of the wind turbine blade, the wind turbine blade having a leading edge (18) and a trailing edge (20) and a suction side (421) extending between the leading edge (18) and the trailing edge (20) and a pressure side (422) extending between the leading edge (18) and the trailing edge (20),
providing a protective cap (310) in accordance with claim 1,
attaching the first attachment portion (403) of the protective cap (310) to the suction side (421) of the wind turbine blade (305) and attaching the second attachment portion (404) of the protective cap (310) to the pressure side (422) of the wind turbine blade (305) such that the protective cap (310) extends along at least a first part (L₁) of the leading edge (18) of the wind turbine blade (310), whereby the first part (L₁) of the leading edge (18) is protected by the protective cap (310).

24. A method in accordance with claim 23, wherein for any wind turbine blade airfoil within the first part (L₁) of the leading edge (18) of the wind turbine blade, the protective cap (310) extends backwards on the pressure side and the suction side at most to a chord coordinate (xₘ) of maximum thickness (tₘ) of said airfoil.

25. A method in accordance with claim 23, further comprising electrically connecting the protective cap (310) to a downconductor connector (432) of the wind turbine blade (305) using a first conductor (433).
